(19) United States
(12) Patent Application Publication
(10) Pub. No.: US 2021/0390301 A1
(43) Pub. Date: Dec. 16, 2021

(54) INDOOR VISION POSITIONING SYSTEM AND MOBILE ROBOT

(71) Applicant: SHEN ZHEN CLEARVISION ROBOTICS, INC, LIMITED, Shenzhen (CN)

(72) Inventors: Jixiang ZHU, Shenzhen (CN); Yang LEI, Shenzhen (CN)

(21) Appl. No.: 16/753,337

(22) PCT Filed: Mar. 3, 2020
(86) PCT No.: PCT/CN2020/077514

§ 371 Date: Apr. 2, 2020

(30) Foreign Application Priority Data
Mar. 8, 2019 (CN) 201920298107.7

(51) Int. Cl. G06K 9/00; G06T 7/70; H04N 5/225; G06K 9/20; H04N 5/232; G02B 5/20; G03B 11/00; G01C 11/02; G01C 21/20; G05D 1/02

(52) U.S. Cl. CPC G06K 9/00664; G06T 7/70; H04N 5/2256; G06K 9/2036; H04N 5/23248; H04N 5/2257; G05D 2201/0216; G03B 11/00; G01C 11/02; G01C 21/206; G05D 1/0246; G05D 1/0274; G02B 5/208

(57) ABSTRACT

The present application provides an indoor vision positioning system and a mobile robot. The indoor vision positioning system is configured to locate a target body, and includes an image acquisition device, an image processing device and a control device; the image acquisition device includes a monochromatic illumination module and a monocular camera both mounted to the target body, and the monocular camera is in communication connection with the image processing device; the image processing device is in communication connection with the control device; the control device is in communication connection with the target body, and controls movement of the target body according to the position data feedback by the image processing device and a preset control parameter.

This application claims priority to Chinese Patent Application No. 201920298107.7 filed on Mar. 8, 2019, the content of which is incorporated herein by reference thereto.

### TECHNICAL FIELD

The present application relates to the field of automatic moving machinery technologies, and particularly to an indoor vision positioning system and a mobile robot.

### BACKGROUND ART

Indoor vision positioning systems have been widely used in industry, and many factories or warehouses have used the indoor vision positioning systems to carry goods. These robots can intelligently and automatically operate under artificial remote control or program control, and can complete handling work efficiently and save labor cost, and can also perform the handling work excellently when facing a stair, an obstacle or rugged ground. The indoor vision positioning systems with intelligent control in the existing warehouses or factories usually use a navigation device to locate themselves and load the goods according to a preset starting place, then transport the goods to an unloading place according to the preset route, and repeat the operation and complete the handling.

In conventional positioning solutions, a method such as laser SLAM (Simultaneous Localization and Mapping), or identifying a two-dimensional code attached at a specific position of ground or ceiling through monocular vision, or identifying an ambient environment through a three-dimensional camera or the like is usually used to realize the vision positioning for the robot. The current indoor vision systems are limited in accuracy and reliability due to the insufficient information processing power and software complexity. Moreover, the two dimensional code is not suitable for dirty or high traffic floors.

### TECHNICAL SOLUTION

A purpose of the present application is to provide an indoor vision positioning system, which aims to solve the technical problems that the current indoor vision positioning systems are of low accuracy without using a two dimensional code, and are immune to dynamic environment.

The present application is realized by an indoor vision positioning system configured to locate a target body. The indoor vision positioning system includes an image acquisition device, an image processing device and a control device;

the image acquisition device comprises a monochromatic illumination module configured to project illumination light with a specific wavelength to an indoor predetermined shooting plane and a monocular camera configured to acquire image characteristic data of the predetermined shooting plane, the monochromatic illumination module and the monocular camera are mounted to the target body, and the monocular camera is in communication connection with the image processing device;

the image processing device is in communication connection with the control device, and is configured to receive the image characteristic data acquired by the monocular camera and convert the image characteristic data into position data; the control device is in communication connection with the target body, and is configured to acquire the position data from the image processing device and control movement of the target body according to the position data and a preset control parameter.

In an embodiment of the present application, the monocular camera includes a lens around which the monochromatic illumination module is mounted and a filter device arranged on the lens and configured to filter indoor ambient light, and a peak value of a light transmission wavelength of the filter device is equal to or close to a light wavelength of the monochromatic lighting module.

In an embodiment of the present application, the filter device includes a narrow-band filter film arranged on the lens, or alternatively includes an optical filter arranged on the lens and a narrow-band filter film arranged on the optical filter; and the narrow-band filter film is configured to filter the indoor ambient light.

In an embodiment of the present application, the monochromatic illumination module includes an infrared LED light source, and a peak value of a light transmission wavelength of the narrow-band filter film is equal to or close to the light wavelength of the monochromatic illumination module.

In an embodiment of the present application, the control device includes a storage module pre-stored with corresponding relationship between the position data and indoor ambient characteristic data.

In an embodiment of the present application, the indoor vision positioning system further includes a stabilization module arranged on the target body and configured to stabilize an illumination direction of the monochromatic illumination module and an image acquisition direction of the monocular camera, and the monochromatic illumination module and the monocular camera are mounted on the target body through the stabilization module.

In an embodiment of the present application, the stabilization module includes a horizontal stabilization module configured to keep a horizontal image acquisition direction of the monocular camera stable, and/or a vertical stabilization module configured to keep the illumination direction of the monochromatic illumination module and the image acquisition direction of the monocular camera facing upward all the time.

In an embodiment of the present application, the indoor vision positioning system further includes a reverse reflective material arranged on the predetermined shooting plane and configured to reflect the light with the specific wavelength emitted by the monochromatic illumination module; and a shape and a position of the reverse reflective material are arranged randomly, and a pattern formed by the reverse reflective material is not rotationally symmetrical.

In an embodiment of the present application, the predetermined shooting plane is a ceiling, and the reverse reflective material is arranged at the same height with the ceiling.

Another aspect of the present application further provides a mobile robot including the indoor vision positioning system as described above.

### ADVANTAGEOUS EFFECTS

The indoor vision positioning system and the mobile robot provided by the present application possess the following technical effects:

the indoor vision positioning system provided by the present application first turns on the monochromatic illumination module when performing vision positioning so as to improve brightness of ambient environment and improve recognition ability of the monocular camera to the ambient environment, and uses the simple and reliable monocular camera to acquire the image characteristic data in a specific direction; the image processing device receives the image characteristic data and compares the image characteristic data with the image-position relationship in the database, the image information is transformed into the position information after processing to realize positioning for the robot, and the control device controls the movement of the robot body based on the position information; the program algorithm is simple and feasible, ensures the accuracy, real-time capability, and reliability of the vision positioning for the indoor vision positioning system, and at the same time greatly reduces the software and hardware cost of the vision positioning for the mobile robot.

### DESCRIPTION OF DRAWINGS

In order to more clearly illustrate the technical solutions in the embodiments of the present application, and the drawings required to be used in the embodiments will be briefly described below. It is not difficult to understand that, the drawings in the following description are only some embodiments of the present application, and other drawings may also be obtained for those of ordinary skill in the art without paying any creative effort based on these drawings.

FIG. 1 is an overall schematic diagram of the indoor vision positioning system provided by an embodiment of the present application.

The specific reference signs involved in the above drawing are as follows:

10—image acquisition device; 11—monochrome illumination module; 12—monocular camera; 20—control device; 30—target body.

### MODE FOR INVENTION

In order to make the purpose, technical solutions and advantages of the present application more clear and comprehensible, the present application will be further described in detail below in combination with the attached drawings and embodiments. It should be understood that the specific embodiments described herein are only used to explain the present application and are not intended to limit the present application.

It should be noted that when a part is referred to as “being fixed to” or “being arranged to” another part, the part may be directly or indirectly placed at another part. When a part is referred to as “being connected to” another part, the part may be directly or indirectly connected to another part. The orientations or positions indicated. by the terms “up”, “down”, “left”, “right”, “front”, “back”, “vertical”, “horizontal”, “top”, “bottom”, “inside”, “outside” etc. are based on the orientations or positions as shown in the accompanying drawings, which are only for convenience of description and cannot be understood as limitations to the technical solutions. The terms “first” and “second” are used for descriptive purposes only and cannot be understood as indicating or implying relative importance or implying the number of technical features. The term “A plurality of” means two or more, unless explicitly and specifically defined otherwise.

In order to illustrate the technical solutions of the present application, details are described below in combination with specific drawings and embodiments.

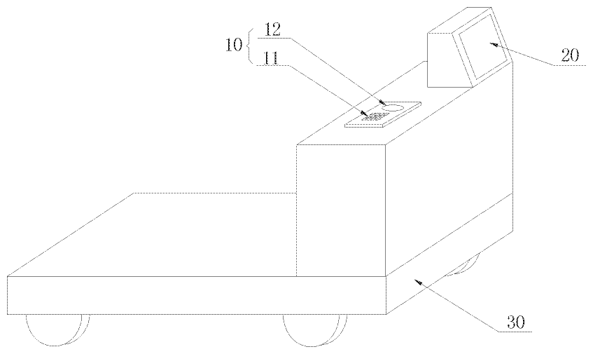

Referring to FIG. 1, the present application is realized by an indoor vision positioning system for positioning a target body 30. The indoor vision positioning system includes an image acquisition device 10, an image processing device (not shown in the figure) and a control device 20. The image acquisition device 10 includes a monochromatic illumination module 11 configured to project illumination light with a specific wavelength to an indoor predetermined shooting plane and a monocular camera 12 configured to acquire image characteristic data of the predetermined shooting plane. The monochromatic illumination module 11 and the monocular camera 12 are mounted to the target body 30, and the monocular camera 12 is in communication connection with the image processing device. The image processing device is in communication connection with the control device 20, and is configured to receive the image characteristic data acquired by the monocular camera 12 and convert the image characteristic data into position data. The control device 20 is in communication connection with the target body 30, and is configured to acquire the position data from the image processing device, and control movement of the target body 30 according to the position data and a preset control parameter.

The indoor vision positioning system provided by the present application operates as follows:

the indoor vision positioning system provided by the present application first turns on the monochromatic illumination module 11 when performing vision positioning so as to improve brightness of ambient environment and improve recognition ability of the monocular camera 12 to the ambient environment, and uses the simple and reliable monocular camera 12 to acquire the image characteristic data in a specific direction; the image processing device receives the image characteristic data and compares the image characteristic data with the image-position relationship in a database, finds out image data in the database with the highest matching degree with the image characteristic data acquired by the camera, and acquires position information of the robot at this time based on this, so that the image information may be transformed into the position information after processing and the robot may be positioned, and the control device 20 controls the movement of the robot body based on the position information.

The indoor vision positioning system provided by the present application has the following beneficial technical effects:

compared with the solutions of traditional indoor vision positioning systems involving vision positioning, the vision positioning procedure algorithm of the indoor vision positioning system provided by the present application is simple and feasible, and ensures the accuracy, real-time performance and reliability of the vision positioning of the indoor vision positioning system, and at the same time greatly reduces the software and hardware cost of the robot vision positioning, which is especially suitable for a mobile robot such as a warehouse handling robot, an automatic restaurant robot or a home robot or the like.

In one embodiment of the present application, the monocular camera 12 includes a lens around which the monochromatic illumination module 11 is mounted and a filter device arranged on the lens and configured to filter indoor ambient light, and a peak value of the light transmission wavelength of the filter device is equal to or close to the light wavelength of the monochromatic lighting module 11.

The beneficial effects of the embodiments of the present application lie in that: the wavelength of the light that can pass through the filter device matches with the wavelength of the light emitted by the monochromatic illumination module 11, and the filter device is configured to filter out light information of other color lights in the image characteristic data; the light emitted by the monochromatic illumination module 11 can effectively improve the signal-to-noise ratio of the image characteristic data, and can especially improve the perception ability of the monocular camera 12 to the image characteristic data under a backlight condition; moreover, the energy utilization efficiency of the illumination module is improved, so that the monochromatic illumination module 11 can use an LED light source with narrow spectrum width and high light intensity as an illumination element, which is conducive to reducing the lighting energy consumption of the indoor vision positioning system, improving the use efficiency of the indoor vision positioning system for the electric energy, and prolonging the use time of the indoor vision positioning system after each charge; as a preferred solution of the embodiments of the present application, the filter device completely covers an object aperture of the monocular camera 12.

In an embodiment of the present application, the filter device includes a narrow-band filter film arranged on the lens, or includes an optical filter arranged on the lens and a narrow-band filter film arranged on the optical filter. The narrow-band filter film is configured to filter the indoor ambient light.

In an embodiment of the present application, the monochromatic illumination module 11 includes an infrared LED light source, and the peak value of the light transmission wavelength of the narrow-band filter film is equal to or close to the light wavelength of the monochromatic illumination module.

As a preferred solution of the embodiments of the present application, the monochromatic illumination module 11 adopts the infrared light-emitting diode of 850 nm as an illumination unit, and adopts the narrow-band filter film with the peak value of the light transmission wavelength being 850 nm. The 850 nm infrared light-emitting diode has a series of advantages, such as small volume, low power consumption, good directivity, etc., which is conducive to saving the energy consumption of the vision positioning module, and has small damage to vision of an operator and has high brightness at the same time, and will not interfere with the operator's vision, thus possesses better man-machine efficiency.

In an embodiment of the present application, the control device 20 includes a storage module pre-stored with corresponding relationship between the position data and the indoor ambient characteristic data.

The indoor vision positioning system provided by the present application performs vision positioning in the following way: the navigation device and the indoor vision positioning system are first mounted on the target body 30 together before the indoor vision positioning system starts to work, and capturing and mapping is performed in the working space, and the database with the relationship between the image characteristic data of the predetermined shooting plane and the position where the target body 30 is located is created; after the monocular camera 12 acquires the image characteristic data of the predetermined shooting plane, the image characteristic data is sent to the image processing device and is compared with an image in the database, and image characteristic data in the database with the highest matching degree with the image characteristic data acquired by the camera is found out, and the position information of the robot is acquired based on this; as a preferable solution of the embodiments of the present application, the time interval or distance interval for capturing should be small enough when the target body 30 with the navigation device captures an image, surveys and maps in the working space, so as to improve the positioning accuracy of the monocular vision of the indoor vision positioning system.

In an embodiment of the present application, the indoor vision positioning system further includes a stabilization module, and the stabilization module is arranged on the target body 30 and configured to stabilize the illumination direction of the monochromatic illumination module 11 and the image acquisition direction of the monocular camera 12; the monochromatic illumination module 11 and the monocular camera 12 are mounted on the target body 30 through the stabilization module.

As a preferable solution of the embodiments of the present application, the illumination direction of the monochromatic illumination module 11 and the direction of the monocular camera 12 to acquire the image characteristic data are both upward, that is to say, the predetermined shooting plane is the indoor ceiling, and the vision positioning module of the indoor vision positioning system is mounted at a position where the line of sight will not be interfered by the load, so that the interference of the arrangement change of indoor articles to the indoor vision positioning system is reduced to the minimum. For example, for a warehouse handling robot, the environment in the warehouse changes in real time with the condition of cargo stacking, however, the indoor vision positioning system is not easy to be interfered and can still accurately locate and guide the warehouse handling robot to perform handling work according to a reference image in the database since the illumination direction of monochromatic illumination module 11 and the image acquisition direction of the monocular camera 12 are stably upward.

In an embodiment of the present application, the stabilization module includes a horizontal stabilization module configured to keep the horizontal image acquisition direction of the monocular camera 12 stable; or the stabilization module includes a vertical stabilization module configured to keep the illumination direction of the monochromatic illumination module 11 and the image acquisition direction of the monocular camera 12 facing upward all the time; or the stabilization module includes the horizontal stabilization module configured to keep the horizontal image acquisition direction of the monocular camera 12 stable and the vertical stabilization module configured to keep the illumination direction of the monochromatic illumination module 11 and the image acquisition direction of the monocular camera 12 facing upward all the time.

The advantages of doing this lie in that: the horizontal stabilization module can make the vision positioning system of the indoor vision positioning system always face toward the same direction, the image captured by the monocular camera 12 can be compared with the images stored in the database without rotation, which is facilitated to simplify the algorithm, reduce the software development cost of the indoor vision positioning system and the requirement for the computing ability; the vertical stabilization module can keep the monocular camera 12 and the monochromatic illumination module 11 facing upward all the time, so that the vision positioning system of the indoor vision positioning system can still operate stably when the indoor vision positioning system encounters a bump or climb.

As an alternative solution of the present application, when the target body 30 turns around without mounting the horizontal stabilization module, the image captured by the monocular camera 12 may be compared with the image characteristic data in the database after being rotated by a certain angle in order to acquire the data of the turning angle of the target body 30, and relevant data of the turning angle and the position of the target body 30 may be determined when the rotation angle and the position information with the highest coincidence degree may be found out.

As an alternative solution of the present application, when the target body 30 encounters a bump without mounting the vertical stabilization module, an inertial measurement unit (IMU) may be used to measure an inclined angle of the target body 30 and correct the position and direction of the visual system in order to acquire the data of the inclined angle of the target body 30, and the image processing device deforms the image acquired by the monocular camera 12 and then compares the deformed image with the image characteristic data in the database, and relevant data of the target body 30 may be determined when the inclined angle and the position information with the highest coincidence degree may be found out.

In case of a bump, the inertial measurement unit (IMU) may be used to measure the inclined angle of the target body 30 and correct the position and direction of the visual system in order to acquire the data of the inclined angle of the target body 30, and the image processing device deforms the image acquired by the monocular camera 12 and then compares the deformed image with the image characteristic data in the database, and relevant data of the target body 30 may be determined when the inclined angle and the position information with the highest coincidence degree may be found out. It should be understood that, when there is no vertical stabilization module mounted, since the image characteristic data in the database is captured and recorded on an inclined road, the inclined angle of the target body 30 at this time is consistent with the inclined angle when the target body 30 with the navigation device created the database, and the image characteristic data acquired by the monocular camera 12 may be matched and compared with the images in the database, so the vision positioning function will not be affected when the target body 30 climbs. In an embodiment of the present application, the indoor vision positioning system further includes a reverse reflective material, and the reverse reflective material is arranged on the predetermined shooting plane and configured to reflect the light with a specific wavelength emitted by the monochromatic illumination module 11.

As a preferable solution of the embodiments of the present application, the reverse reflective material may be a high reflective material such as an 3M diamond level, a super reverse reflective film, a reverse reflective film for vehicles, etc. A beneficial effect of the embodiments of the present application lies in that: the reflection coefficient of the reverse reflective material for the light emitted by the monochromatic illumination module 11 is far greater than that of the ceiling or side wall of the warehouse system, and the monocular camera 12 may acquire an image signal with clear light and dark through arranging a reverse reflective plate, thereby further improving the signal-to-noise ratio of the monocular vision positioning system, this is beneficial to acquire the accurate position information of the indoor vision positioning system in the warehouse by the image processing device.

The shape and position of the reverse reflective material are arranged randomly, and the beneficial effect for doing this lies in that: the reverse reflective material with the shape and position randomly arranged can make the image characteristic data in the database corresponding to various positions in the warehouse system different, and it will not occurred that two positions correspond to the same image characteristic data, alternatively it is advantageous for the accurate positioning of indoor vision positioning system when the approximation of the image characteristic data corresponding to two positions is too high.

In an embodiment of the present application, the predetermined shooting plane is a ceiling, and the reverse reflective material is arranged at the same height with the ceiling. The beneficial effect for doing this lies in that: for an uneven ceiling, the reverse reflective materials are stuck onto the same height, so that the parts with high brightness in the image acquired by the image acquisition device 10 is located at the same height, and the contribution of the bright area of the image to the image acquisition device 10 in identifying the position of the indoor vision positioning system is far greater than the dark areas with different heights, and it is more accurate to perform positioning by utilizing the acquired information about peak values.

Another aspect of the present application further provides a mobile robot including the indoor vision positioning system as described above.

The above description only described preferable embodiments of the present application, and is not used to limit the present application. Any modification, equivalent substitution and improvement made within the spirit and principle of the present application shall be included in the protection scope of the present application.

1. An indoor vision positioning system configured to locate a target body, wherein the indoor vision positioning system comprises an image acquisition device, an image processing device and a control device:
wherein the image acquisition device comprises a monochromatic illumination module configured to project illumination light with a specific wavelength to an indoor predetermined shooting plane and a monocular camera configured to acquire image characteristic data of the predetermined shooting plane, the monochromatic illumination module and the monocular camera are mounted to the target body, and the monocular camera is in communication connection with the image processing device;
wherein the image processing device is in communication connection with the control device, and is configured to receive the image characteristic data acquired by the monocular camera and convert the image characteristic data into position data;
wherein the control device is in communication connection with the target body, and is configured to acquire the position data from the image processing device and control movement of the target body according to the position data and a preset control parameter.

2. The indoor vision positioning system according to claim 1, wherein the monocular camera comprises a lens around which the monochromatic illumination module is mounted and a filter device arranged on the lens and configured to filter indoor ambient light, and a peak value of a light transmission wavelength of the filter device is equal to or close to a light wavelength of the monochromatic lighting module.

3. The indoor vision positioning system according to claim 2, wherein the filter device comprises a narrow-band filter film arranged on the lens, and the narrow-band filter film is configured to filter the indoor ambient light.

4. The indoor vision positioning system according to claim 3, wherein the monochromatic illumination module comprises an infrared LED light source, and a peak value of a light transmission wavelength of the narrow-band filter film is equal to or close to the light wavelength of the monochromatic illumination module.

5. The indoor vision positioning system according to claim 2, wherein the filter device comprises an optical filter arranged on the lens and a narrow-band filter film arranged on the optical filter, and the narrow-band filter film is configured to filter the indoor ambient light.

6. The indoor vision positioning system according to claim 5, wherein the monochromatic illumination module comprises an infrared LED light source, and a peak value of a light transmission wavelength of the narrow-band filter film is equal to or close to the light wavelength of the monochromatic illumination module.

7. The indoor vision positioning system according to claim 1, wherein the control device comprises a storage module pre-stored with corresponding relationship between the position data and indoor ambient characteristic data.

8. The indoor vision positioning system according to claim 1, wherein the indoor vision positioning system further comprises a stabilization module arranged on the target body and configured to stabilize an illumination direction of the monochromatic illumination module and an image acquisition direction of the monocular camera, and the monochromatic illumination module and the monocular camera are mounted on the target body through the stabilization module.

9. The indoor vision positioning system according to claim 8, wherein the stabilization module comprises a horizontal stabilization module configured to keep a horizontal image acquisition direction of the monocular camera stable, and/or a vertical stabilization module configured to keep the illumination direction of the monochromatic illumination module and the image acquisition direction of the monocular camera facing upward all the time.

10. The indoor vision positioning system according to claim 9, wherein the indoor vision positioning system further comprises a reverse reflective material arranged on the predetermined shooting plane and configured to reflect the light with the specific wavelength emitted by the monochromatic illumination module;
wherein a shape and a position of the reverse reflective material are arranged randomly, and a pattern formed by the reverse reflective material is not rotationally symmetrical.

11. The indoor vision positioning system according to claim 10, wherein the predetermined shooting plane is a ceiling, and the reverse reflective material is arranged at the same height with the ceiling.

12. A mobile system, comprising a robot body, wherein the mobile system further comprises the indoor vision positioning system according to claim 1, and the robot body is the target body.

13. The mobile system according to claim 12, wherein the monocular camera comprises a lens around which the monochromatic illumination module is mounted and a filter device arranged on the lens and configured to filter indoor ambient light, and a peak value of a light transmission wavelength of the filter device is equal to or close to a light wavelength of the monochromatic lighting module.

14. The mobile system according to claim 13, wherein the filter device comprises a narrow-band filter film arranged on the lens, and the narrow-band filter film is configured to filter the indoor ambient light.

15. The mobile system according to claim 14, wherein the monochromatic illumination module comprises an infrared LED light source, and a peak value of a light transmission wavelength of the narrow-band filter film is equal to or close to the light wavelength of the monochromatic illumination module.

16. The mobile system according to claim 13, wherein the filter device comprises an optical filter arranged on the lens and a narrow-band filter film arranged on the optical filter, and the narrow-band filter film is configured to filter the indoor ambient light.

17. The mobile system according to claim 16, wherein the monochromatic illumination module comprises an infrared LED light source, and a peak value of a light transmission wavelength of the narrow-band filter film is equal to or close to the light wavelength of the monochromatic illumination module.

18. The mobile system according to claim 12, wherein the control device comprises a storage module pre-stored with corresponding relationship between the position data and indoor ambient characteristic data.

19. The mobile system according to claim 12, wherein the indoor vision positioning system further comprises a stabilization module arranged on the target body and configured to stabilize an illumination direction of the monochromatic illumination module and an image acquisition direction of the monocular camera, and the monochromatic illumination module and the monocular camera are mounted on the target body through the stabilization module.

20. The mobile system according to claim 19, wherein the stabilization module comprises a horizontal stabilization module configured to keep a horizontal image acquisition direction of the monocular camera stable, and/or a vertical stabilization module configured to keep the illumination direction of the monochromatic illumination module and the image acquisition direction of the monocular camera facing upward all the time.
